(19) United States
(12) Patent Application Publication
(10) Pub. No.: US 2003/0221377 A1
(43) Pub. Date: Dec. 4, 2003

(54) Monument marker for grave-site

(76) Inventors: Dewey W. Crawford, Longview, TX (US); Teresa S. Crawford, Longview, TX (US)

Correspondence Address: THOMAS B. LUEBBERING, HOVEY WILLIAMS LLP, Suite 400, 2405 Grand, Kansas City, MO, 64108, US

(21) Appl. No.: 10/163,141

(22) Filed: Jun. 4, 2002

(51) Int. Cl. E01F 9/011; E04H 13/00; G09F 19/00; F21L 4/00; F21L 13/00; F21V 9/00

(52) U.S. Cl. 52/103; 52/104; 40/124.5; 362/231; 362/183

(57) ABSTRACT

A monument marker (10) broadly comprises an ornament (14) for providing an aesthetic display, a pedestal (22) for supporting the ornament (14), a mirror (24) secured to the pedestal (22) for reflecting light onto the ornament (14), a light source (16) for generating the light, and a power source (18) for providing power to the light source (16). The ornament (14) is preferably semitransparent thereby allowing the light from the light source (16) to permeate and refract therethrough. The pedestal (22) is preferably hollow and preferably opens thereby allowing the pedestal (22) to contain one or more mementos. For example, the pedestal (22) may contain the mementos in the form of sports memorabilia, such as golf balls and/or baseball cards. Alternatively, the pedestal (22) may be solid and molded around the mementos and/or the mirror (24).

### BACKGROUND OF THE INVENTION

1. Field of the Invention

The present invention relates to grave-site monument markers. More particularly, the present invention relates to a monument marker for beautifying a grave-site.

2. Description of Prior Art

People often desire to decorate and personalize grave-sites of deceased loved ones. A commonly accepted method of decorating a grave-site is to place flowers at the grave-site. However, flowers must be periodically replaced and are often removed by cemetery grounds keepers. Moreover, flowers do not serve to emphasize a particular former interest of the deceased, for example, that the deceased was an avid golfer or devout church-goer.

People also often desire to mark grave-sites in such a manner to distinguish a particular grave-site from other grave-sites. Because grave-site monuments are typically stone tablets with similar characteristics, it can be difficult to distinguish one grave-site from another. Flowers left at a particular grave-site may be the most readily apparent means of distinguishing that particular grave-site; however, flowers are often removed and are commonly placed at many sites and therefore do not easily distinguish one grave-site from another.

Another method of distinguishing a grave-site is to illuminate it with lighting. Unfortunately, lighting a particular grave-site is typically costly and time consuming and only possible when a source of power is nearby and readily accessible.

Accordingly, there is a need for an improved monument marker that overcomes the limitations of the prior art.

### SUMMARY OF THE INVENTION

The present invention overcomes the above-identified problems and provides a distinct advance in the art of monument markers. More particularly, the present invention provides a relatively inexpensive monument marker that both beautifies and customizes a grave-site in a tasteful manner.

The marker is preferably placed on or adjacent to a grave-site monument of a deceased person. The marker broadly comprises an ornament for providing an aesthetic display, a pedestal for supporting the ornament, a mirror secured to the pedestal for reflecting light onto the ornament, a light source for generating the light, and a power source for providing power to the light source. The ornament is preferably semitransparent thereby allowing the light to permeate and refract therethrough. The ornament may also be colored in order to add additional visual effects to the marker. The ornament preferably reflects a former hobby, habit, or characteristic of the deceased person so as to customize the grave-site of that person. For example, the ornament may be a three-dimensional angel, golfer, other figurine, or any other item associated with the deceased person.

The pedestal is preferably hollow and configured to be opened thereby allowing the pedestal to accept one or more mementos therein. For example, the pedestal may contain mementos in the form of flowers or sports memorabilia, such as golf balls and/or baseball cards. Alternatively, the pedestal may be solid and molded around the mementos and/or the mirror.

The mirror is preferably mounted to a bottom surface of the pedestal and may be either mounted inside or outside of the pedestal. The mirror receives the light from the light source through the pedestal and reflects the light back through the pedestal toward the ornament. Therefore, care should be taken to not overload the pedestal with too many mementos and thereby prevent the light from being reflected onto the ornament.

The light source may shine the light on the ornament either directly or indirectly using the mirror. The light source is preferably an incandescent lamp but may be any light generating device, such as a light emitting diode. The light source may also provide colored light in order to add additional visual effects to the marker. The light source is preferably enclosed within a housing.

The power source is preferably also enclosed within the housing and may include a battery and/or a solar panel in order to power the light source where no other power source is available. The solar panel may used to charge the battery. Alternatively, the solar panel may be used without the battery and provide power directly to the light source.

The power source may also include a light detector, such as a light sensitive diode, that may be used to turn the light source off and on. For example, the light detector may be used to turn the light source off during the day and on at night thereby allowing the solar panel to more fully charge the battery during the day and allowing the light source to operate at only night when the light may be more easily seen. Alternatively, the light detector may be configured to turn the light source on during the day and off at night thereby conserving power stored in the battery.

In an alternative embodiment, the ornament is a two dimensional design etched in a top surface of the pedestal. When used in conjunction with the alternate embodiment of the ornament, the housing described above is preferably secured within the pedestal thereby allowing the pedestal to be mounted flush with the ground or another surface. One advantage of the alternate embodiment of the ornament is that the marker may be permanently installed in the ground while not inhibiting normal grave-site maintenance, such as lawn-mowing.

### BRIEF DESCRIPTION OF THE DRAWINGS

A preferred embodiment of the present invention is described in detail below with reference to the attached drawing figures, wherein:

FIG. 1 is a perspective view of a monument marker constructed in accordance with a preferred embodiment of the invention and shown next to a monument of a grave-site for beautifying the grave-site;

FIG. 2 is an enlarged perspective view of the marker without the monument;

FIG. 3 is a schematic diagram of certain electrical components of the marker; and

FIG. 4 is a plan view of an alternative embodiment of an ornament for the marker.

### DETAILED DESCRIPTION OF A PREFERRED EMBODIMENT

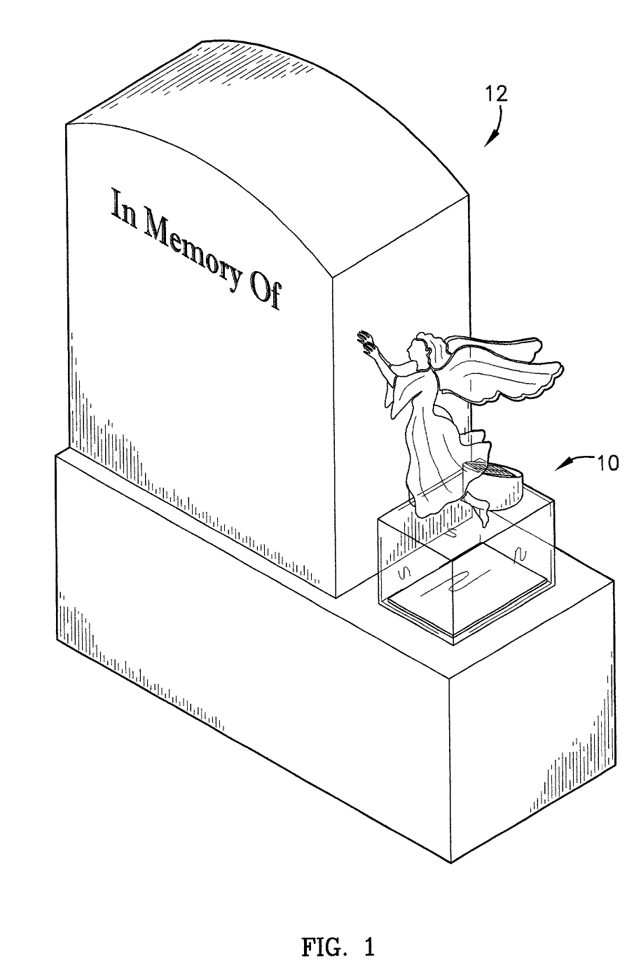

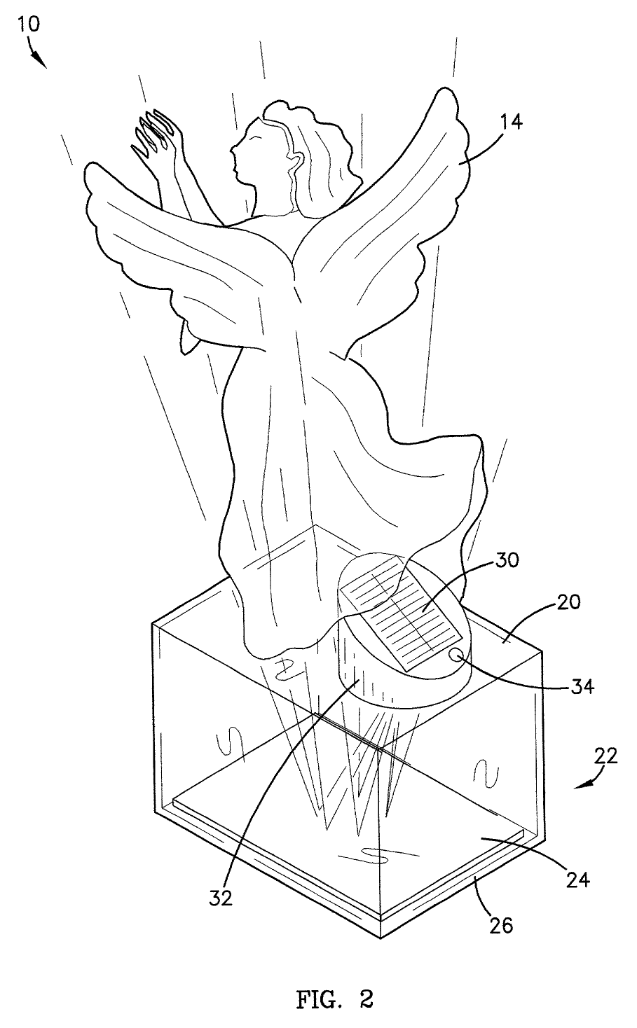

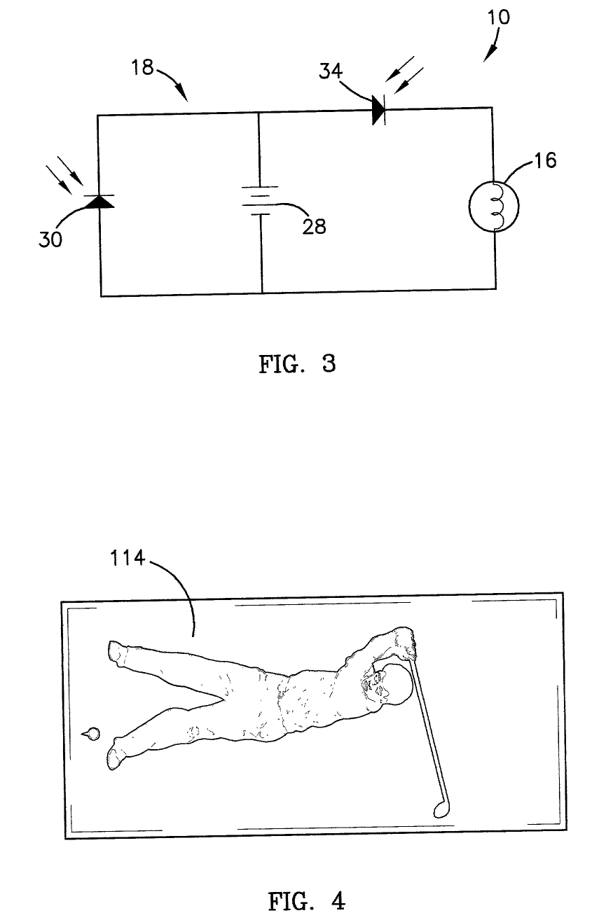

Referring to FIG. 1, a monument marker 10 constructed in accordance with a preferred embodiment of the present invention is illustrated resting on a monument or tombstone 12 of a grave-site of a deceased person. Referring also to FIGS. 2-3 the marker 10 broadly comprises an ornament 14 for providing an aesthetic display, a light source 16 for shining light onto the ornament 14, and a power source 18 for providing power to the light source 16.

The ornament 14 is preferably semitransparent thereby allowing the light to permeate and refract therethrough. The ornament 14 may also be colored in order to add additional visual effects to the marker 10. The ornament 14 preferably reflects a former hobby, habit, or characteristic of the deceased person so as to customize the grave-site of that person. For example, the ornament 14 may be a three-dimensional angel, golfer, other figurine, or any other item associated with the deceased person.

The ornament 14 is preferably secured to a top surface 20 of a pedestal 22 which is also preferably semitransparent. The ornament 14 may be secured to the top surface 20 using adhesives, screws, or other commonly used means. Additionally, the ornament 14 and the top surface 20 may be molded as a singe unit.

Both the ornament 14 and the pedestal 22 are preferably made of acrylic but may be made of any semi-transparent material. The pedestal 22 is preferably in the form of a box that is approximately five inches wide, approximately six inches deep, and approximately three inches high. However, the pedestal 22 may be of another shape, such as a column.

The pedestal 22 may also contain a mirror 24 for reflecting the light from the light source 16 onto the ornament 14. The pedestal 22 may also include mounting hardware allowing the pedestal 22 to be mounted to a vertical surface, such as a wall of a mausoleum or a face of the monument 12.

The pedestal 22 is preferably hollow and configured to be opened thereby allowing the pedestal 22 to accept one or more mementos, such as flowers or any item associated with the deceased person. For example, the pedestal 22 may contain the mementos in the form of sports memorabilia, such as golf balls and/or baseball cards. Alternatively, the pedestal 22 may be solid and molded around the mementos and/or the mirror 24.

The mirror 24 is preferably mounted to a bottom surface 26 of the pedestal 22 and may be either mounted inside or outside of the pedestal 22. The mirror 24 receives the light from the light source 16 through the pedestal 22 and reflects the light back through the pedestal 22 toward the ornament 14. Therefore, care should be taken to not overload the pedestal 22 with too many mementos and thereby prevent the light from being reflected onto the ornament 14.

The light source 16 may shine the light on the ornament 14 either directly or indirectly using the mirror 24. The light source 16 is preferably an incandescent lamp but may be any light generating device, such as a light emitting diode. Through testing, it has been found that the light source 16 preferably consumes 1.4 or more watts of power in order to provide sufficient light. The light source 16 may also provide colored light in order to add additional visual effects to the marker 10. It is anticipated that colored light may require more power in order to provide sufficient light.

The power source 18 preferably includes a battery 28 and/or a solar panel 30 in order to power the light source 16 where no other power source is available. The battery 28 may be replaceable and/or charged through any conventional charging means. Additionally, the solar panel 30 may used to charge the battery 28. Alternatively, the solar panel 30 may be used without the battery 28 and provide power directly to the light source 16.

The power source 18 is preferably enclosed within a housing 32. Additionally, the light source 16 may also be enclosed within the housing 32. The housing 32 is preferably secured to the top surface 20 of the pedestal 22 and may be either mounted inside or outside of the pedestal 22. The housing 32 may also be semitransparent and made of acrylic. Alternatively, the housing 32 may be designed to match the monument 12.

The power source 18 may also include a light detector 34, such as a light sensitive diode, that may be used to turn the light source 16 off and on. For example, the light detector 34 may be used to turn the light source 16 off during the day and on at night thereby allowing the solar panel 30 to more fully charge the battery 28 during the day and allowing the light source 16 to operate only at night when the light may be more easily seen. Alternatively, the light detector 34 may be configured to turn the light source 16 on during the day and off at night thereby conserving power stored in the battery 28.

Referring to FIG. 4, an alternative embodiment of the ornament 114 is a two dimensional design etched in the top surface 20 of the pedestal 22. When used in conjunction with the alternate embodiment of the ornament 114, the housing 32 described above is preferably secured within the pedestal 22 thereby allowing the pedestal 22 to be mounted flush with the ground or another surface. One advantage of the alternate embodiment of the ornament 114 is to allow the marker 10 to be permanently installed in the ground while not inhibiting normal grave-site maintenance, such as lawn-mowing.

While the present invention has been described above, it is understood that other materials and/or dimensions can be substituted. Additionally, the marker 10 may be designed to mount flush with a vertical surface, such as the wall of the mausoleum. In this case, references in this document to the top surface 20 and the bottom surface 26 would be replaced with references to an exposed surface and a recessed surface, respectively. These and other minor modifications are within the scope of the present invention.

Having thus described a preferred embodiment of the invention, what is claimed as new and desired to be protected by Letters Patent includes the following:

1. A monument marker for beautifying a grave-site, the marker comprising:
a light source operable to generate light; and
a semitransparent ornament operable to refract the light, thereby providing an aesthetic display.

2. The marker as set forth in claim 1, further comprising a mirror operable to reflect the light from the light source onto the ornament.

3. The marker as set forth in claim 1, further comprising a pedestal operable to support the ornament.

4. The marker as set forth in claim 3, wherein the pedestal is semitransparent and further operable to contain mementos.

5. The marker as set forth in claim 3, wherein the pedestal is operable to be attached to a vertical surface.

6. The marker as set forth in claim 3, wherein the ornament is a design etched into a surface of the pedestal.

7. The marker as set forth in claim 1, wherein the ornament is a three dimensional figurine.

8. The marker as set forth in claim 1, further comprising a power source including a battery thereby allowing the marker to be used where no other power source is available.

9. The marker as set forth in claim 8, wherein the power source further includes a solar panel operable to charge the battery thereby allowing the marker to be used indefinitely.

10. The marker as set forth in claim 1, further comprising a power source including a solar panel thereby allowing the marker to be used where no other power source is available.

11. The marker as set forth in claim 1, further comprising a light detector operable to detect sunlight and thereby control the light source.

12. The marker as set forth in claim 1, wherein the ornament is colored.

13. The marker as set forth in claim 1, wherein the light source generates colored light.

14. A monument marker for beautifying a grave-site, the marker comprising:
a light source operable to generate light;
a semitransparent ornament operable to refract the light, thereby providing an aesthetic display;
a pedestal operable to contain mementos and support the ornament; and
a mirror attached to a bottom surface of the pedestal and operable to reflect the light onto the ornament.

15. The marker as set forth in claim 14, further comprising a power source including a battery and a solar panel.

16. The marker as set forth in claim 15, wherein the power source further includes a light detector operable to detect sunlight and thereby control the light source.

17. The marker as set forth in claim 14, wherein the ornament is a three dimensional figurine.

18. The marker as set forth in claim 14, wherein the ornament is a design etched into a substantially flat surface of the pedestal.

19. The marker as set forth in claim 14, wherein at lease a portion of the marker is colored.

20. A monument marker for beautifying a grave-site, the marker comprising:
a light source operable to generate light;
a light detector operable to detect sunlight and thereby control the light source;
a battery operable to provide power to the light source where no other power source is available;
a solar panel operable to charge the battery;
a three dimensional semitransparent ornament operable to refract the light, thereby providing an aesthetic display;
a pedestal operable to contain mementos and support the ornament; and
a mirror attached to a bottom surface of the pedestal and operable to reflect the light onto the ornament.
